(19) United States
(12) Patent Application Publication
(10) Pub. No.: US 2026/0057169 A1
(43) Pub. Date: Feb. 26, 2026

(54) SYSTEM AND METHOD FOR CONTEXTUAL SANITIZATION AND RE-ENRICHMENT OF DOCUMENT

(71) Applicant: Accenture Global Solutions Limited, Dublin (IE)

(72) Inventors: Malek BEN SALEM, Falls Church, VA (US); Louis DIVALENTIN, Arlington, VA (US); Aolin DING, McLean, VA (US)

(21) Appl. No.: 18/811,540

(22) Filed: Aug. 21, 2024

(51) Int. Cl. G06F 40/166; G06F 16/901; G06F 21/60

(52) U.S. Cl. CPC G06F 40/166; G06F 16/9024; G06F 21/60

(57) ABSTRACT

The present disclosure relates to a technique for context sanitization and re-enrichment of a document. A user sends a document containing restricted confidential information and a list of questions to run on an outside model to a third party. To maintain confidentiality, the document is processed internally in the organization to generate a knowledge graph for replacing confidential information with fake information before sending document to the third-party model. The document after running on the third-party model generates a summary document with fake information. The received summary document from the third-party model is then re-enriched by replacing fake information with original confidential information. The confidential information of the organization is thus secured and not shared with third parties to enhance data security of the organization.

### FIELD OF THE INVENTION

Various embodiments described herein generally relate to information security in documents. More specifically, the present disclosure relates to a technique for information sanitization and re-enrichment of a document.

### BACKGROUND

Secrets are pieces of information that should remain confidential, but unlike Personal Identifiable Information (PII), secrets depend on the context of the information to determine the confidentiality. These are items like material nonpublic information or business-specific sensitive operational information. Scanning for such confidential information can be extremely difficult using conventional solutions as there are no forms or patterns and the information currently relies on human judgements and socio-cultural context. However, manually accessing such confidential information and then replacing it results in accelerating workflows. Also, the conventional approaches are resource-intensive and prone to information mismanagement as well as errors, which is an inefficient technique.

### SUMMARY

Implementations of the present disclosure are generally directed to a contextual sanitization and enrichment of information in a document. Specifically, implementations of the present disclosure are directed to a technique to replace restricted information in the document with fake information while sending the document to a third party. The third party has a GAI based model (GAI based model/machine learning model/Generative AI multimodal model are interchangeably referred to as model) to generate an analyzed and summarized report (may be referred to as report). The report received back to a user from the third party is re-enriched by replacing fake information with original information to generate a meaningful report.

According to an embodiment of the invention, a method is disclosed. The method includes: receiving a first document containing restricted information and a list of questions for the first document; generating a graph based on answers to the questions of the list, the graph including nodes and edges connecting the nodes, the nodes representing attributes in the first document, and the edges representing relationships reflected in the document between the attributes of the nodes; flagging those of the nodes that contain any of the restricted information within the first document; generating, for each of the flagged nodes, fake information to replace the restricted information of the flagged node; generating a second document by replacing the restricted information of the first document with the fake information from the flagged nodes; receiving a third document, the third document being a content modified version of the second document, the third document including at least some of the fake information of the flagged nodes; identifying, within the third document, content corresponding to edges of at least some of the flagged nodes and nodes connected to the edges of the at least some of the flagged nodes; identifying, from the identified edges and the identified nodes connected to the edges, specific flagged nodes; and generating a fourth document by replacing any of the fake information in the third document with restricted information taken from the specific flagged nodes.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

### BRIEF DESCRIPTION OF DRAWINGS Various embodiments in accordance with the present disclosure will be described with reference to the drawings, in which:

FIG. 1 illustrates an exemplary block diagram of a secret scrapper system in the existing art.

FIG. 2 illustrates an exemplary block diagram of a context sanitization and re-enrichment model, in accordance with the present disclosure.

FIG. 3A illustrates a knowledge graph with original data and FIG. 3B illustrates a knowledge graph with fake data, in accordance with present disclosure.

FIG. 4 illustrates a flow diagram that presents an example method for context sanitization and re-enrichment of the confidential information in the document, in accordance with present disclosure.

FIG. 5 illustrates a context sanitization and re-enrichment system architecture, in accordance with the present disclosure.

FIG. 6 illustrates an exemplary flow diagram as an example model 200 to generate an automated sanitized document.

FIG. 7 illustrates an example regarding confidential information for generation of prompt, in accordance with the present disclosure.

FIG. 8 illustrates examples disclosing common sample list of secrets for extraction.

FIG. 9 illustrates a general computing environment for in accordance with the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

References to one or an embodiment in the present disclosure can be, but not necessarily are, references to the same embodiment; and such references mean at least one of the embodiments.

Reference to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented. The term “learning model” is defined to be essentially conforming to the particular dimension, shape, or other feature that the term modifies, such that the component need not be exact. For example, “graph may be defined as knowledge graph, sanitized may be defined as redacted, filler information may be defined as fake value or fake information and confidential may be defined as restricted.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected. Non-numerical uses of “about”carry similar variation.

“First,” “second,” etc., re labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

For simplicity and illustrative purposes, the present disclosure is described by referring mainly to examples thereof. The examples of the present disclosure described herein may be used together in different combinations. In the following description, details are set forth in order to provide an

In a particular example, a method for contextual sanitization and re-enrichment of information of document may be disclosed. The method includes a step of receiving, from a user device, a first document containing restricted information and a list of questions for the first document. The method further includes a step of generating, by the processor, a graph based on answers to the list of questions. The graph includes nodes and edges in which the edges connect different nodes based on relations between the different nodes. The nodes represent attributes in the first document and the edges represent relationship reflected in the first document between the attributes of the nodes. The method also includes a step of flagging, by the processor, flagging the nodes that contain any restricted information within the first document. The method additionally includes a step of generating, by the processor (a generation engine), a second document by replacing the restricted information of the first document with the fake information from the flagged nodes. The method also includes a step of receiving, by the processor, a third document generated as a content modified version of the second document by passing the second document through a Generative AI multimodal model, such as but not limited to Large Language model (LLM). The third document includes at least some of the fake information of the flagged nodes. The method also includes a step of identifying, by the processor, within the third document, content corresponding to edges of at least some of the flagged nodes and nodes connected to the edges of the at least some of the flagged nodes. The processor further identifies from these identified edges and these identified nodes connected to the edges, specific flagged nodes. The method additionally includes a step of generating, by the processor, a fourth document by replacing the fake information in the third document with restricted information taken from the specific flagged nodes.

In a particular example, a computer implemented non-transitory computer readable media is disclosed that contains instructions programmed to cause an electronic computer system to perform operations comprising: receiving a first document containing restricted information and a list of questions for the first document; generating a graph based on answers to the questions of the list, the graph including nodes and edges connecting the nodes, the nodes representing attributes in the first document, and the edges representing relationships reflected in the document between the attributes of the nodes; flagging those of the nodes that contain any of the restricted information within the first document; generating, for each of the flagged nodes, fake information to replace the restricted information of the flagged node; generating a second document by replacing the restricted information of the first document with the fake information from the flagged nodes; receiving a third document, the third document being a content modified version of the second document, the third document including at least some of the fake information of the flagged nodes; identifying, within the third document, content corresponding to edges of at least some of the flagged nodes and nodes connected to the edges of the at least some of the flagged nodes; identifying, from the identified edges and the identified nodes connected to the edges, specific flagged nodes; and generating a fourth document by replacing any of the fake information in the third document with restricted information taken from the specific flagged nodes.

In a particular example, a system for contextual sanitization and re-enrichment of information in document is disclosed. The system further discloses a non-transitory computer readable memory storing instructions and a processor programmed to cooperate with the instructions in memory to perform operations. The system receives a first document, from a user device, the first document containing restricted information and a list of questions for the first document. The system generates a knowledge graph based on answers to the list of questions. The graph includes nodes and edges in which the edges connect to different nodes based on relations between the different nodes. The nodes represent attributes in the first document and the edges represent relationship reflected in the first document between the attributes of the nodes. The computer system includes flagging the nodes that contain any restricted information within the first document. The system further includes generating fake information to replace the restricted information of the flagged node, for each of the flagged nodes. The system then generates a second document by replacing the restricted information of the first document with the fake information from the flagged nodes. Further, the system receives a third document generated as a content modified version of the second document by passing the second document through a Generative AI multimodal model (interchangeably referred to as machine learning model or ML model), such as but not limited to Large Language model (LLM). The third document includes at least some of the fake information of the flagged nodes. The Generative AI multimodal model identify content corresponding to edges of some of the flagged nodes and nodes connected to the edges of the at least some of the flagged nodes within the third document. Further, the system identifies specific flagged nodes from the identified edges and the identified nodes connected to the edges. The Generative AI multimodal model then generates a fourth document by replacing the fake information in the third document with restricted information taken from the specific flagged nodes.

In other examples, the above examples may disclose various optional features. The third document lacks at least some of the fake information contained in the graph, such that a number of specific flagged nodes is less than the flagged nodes from the generating a graph. Any of the flagged nodes from the generating a graph that are not part of the specific flagged nodes correspond to restricted information in the first document for which no corresponding fake information appears in the third document. Generating fake information for a numerical value of restricted information comprises determining a range around the numerical value and selecting a random number within the determined range. Generating fake information for a name of restricted information comprises converting the name to a fake name or a generic descriptor of the name.

Further, maintaining a plurality of lists of questions, each of the list of questions being context specific to a certain industrial area; and selecting the list of questions, for the receiving a first document, from the plurality of lists of questions. The restricted information can be any of: historical or forecasted revenues, earnings or other financial results; new products or services or other product developments; new contracts or partners or loss of a contract or partner; developments regarding technology or business operations; cybersecurity or privacy breaches; potential mergers or acquisitions or dispositions of significant subsidiaries or assets; new litigation or regulatory inquiries or developments in existing litigation or inquiries; developments in borrowings, or financings or capital investments; changes in financial condition or asset value or liquidity issues; changes in senior management; changes in compensation policies; changes related to auditors; changes in corporate strategy; changes in accounting methods and write-offs; and stock offerings, stock splits or changes in dividend policy.

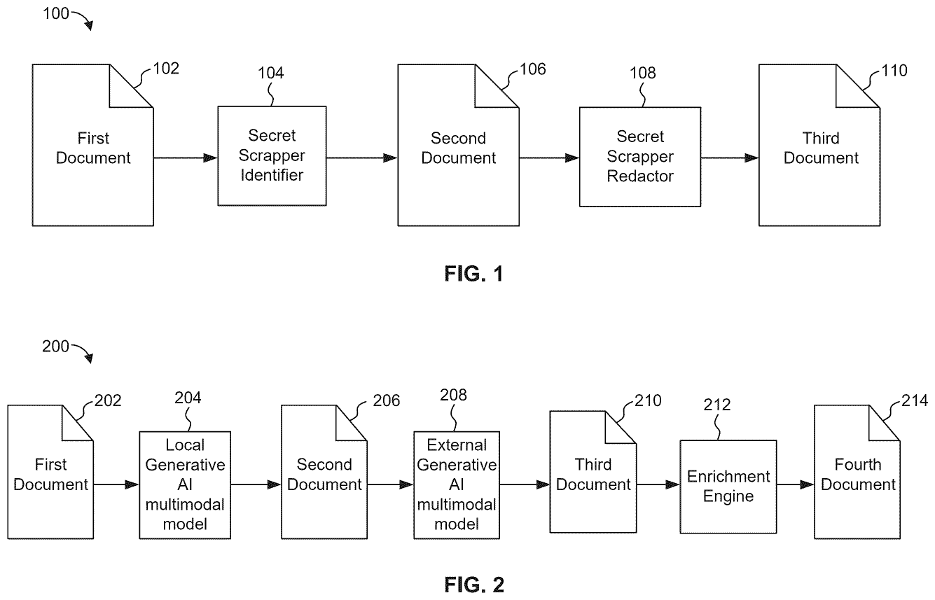

The traditional secret scrapper systems have multiple technical issues and other drawbacks. For example, the traditional secret scrapper system fails to provide enrichment to the reports generated by the traditional secret scrapper system that may not require any user engagement. Moreover, even if confidential information is replaced by fake values, or black bar having a fixed size or any other markers initially, a summary generated for an end user includes fake values or black bar or any other markers only, that makes no sense about the document for the end user. To receive meaningful report for the end user, most of the times, the original document with confidential information is shared with the third party, raising alarming concerns regarding breach of confidentiality. An exemplary implementation of the traditional system is explained below with reference to FIG. 1.

FIG. 1 illustrates an exemplary block diagram of a secret scrapper system in the existing art. The secret scrapper disclosed in the existing knowledge is for redacting confidential information (interchangeably referred to as secret information) from the documents. FIG. 1. discloses a block diagram of a system for context sanitization and replacement of sanitized information with filler (filler may interchangeably be referred to as fake information or fake values). The secret scrapper 100 is implemented in hardware or a suitable combination of hardware and software. The secret scrapper 100 receives a first document 102 as an input from a user device coupled to a database of the organization. The first document 102 is passed through a secret scrapper identifier 104 to identify secret information in the first document 102 to generate a second document 106. The second document 106 is then passed through a secret scrapper redactor 108 to redact the identified secret information. The secret scrapper summary is a third document 110 produced for an end user. The third document 110 is a generated useless summary report without any context that does not add any value for the user. Generating the third document with redacted information using redaction technique loses context and there is no clue or hint to fill the original content back in place of redacted information in the absence of the context. If the first document is directly passed to external model to generate meaningful summary report, then there is high risk of losing user's confidential information. Moreover, a complication is that many of the second documents still contains secret information that is not acceptable for sending the document externally to the third party, as the secret information being confidential depends on one or more formats in which the context is used in the document.

In some examples, information being private, or public depends on its use in different settings. In other examples, human judgments about privacy are considered based on socio-cultural context. Machine learning (ML) models struggle with understanding context, impacting their handling of private information. The private information can be expressed in various forms, making it hard to identify. ML models struggle with delineating boundaries around text referencing secrets, like in conversations about sensitive topics. Moreover, it is difficult for ML models to determine who is privy to a secret (the in-group) is complex and evolves over time. This complexity challenges privacy models like differential privacy, which attempt to provide guarantees about information sharing. ML models currently lack in understanding conversational rules and social norms to decide what, how much, and with whom to share of these human notions of privacy. Thus, there are complexities of managing privacy in language models, emphasizing the need for a deep understanding of context, the dynamic nature of privacy, and the nuances of human communication.

For example, it is a common practice for a company to want to process (e.g., summarize, extract) a document in a manner that would change the document. It is typically more cost effective to send the document to a lower cost third party vendor to perform the processing. However, if the document contains confidential information (e.g., restricted, trade secret, classified, non-public, etc.) the company cannot transfer the document as it is to the vendor without revealing the secret information.

The company must therefore scrub the document of the confidential information, such as by replacing the confidential information with markers (e.g., symbols or placeholder words). When the revised document returns, it will include the markers, which the company can then replace with the original words from the original document.

The above methodology presents several technical problems. A first technical problem, as noted above, is the documents lacks forms or patterns, and thus identification of confidential content relies upon subjective human judgements and socio-cultural context. For example, a phrase “there is a bomb set to go off” and “that performance was the bomb” both use word “bomb,” one in a malevolent context that might indicate confidential information that needs to be removed, while the other in a playful context that does not. While the first phrase would almost certainly be flagged as confidential content, flagging of the second phrase would be inconsistent based upon whether a human reviewer move valued the presence of the word rather than the content in which the word appears. Traditional methods have no mechanism to make the distinction, and thus will generate inaccurate results.

A second technical problem is that, when the processed document returns from the vendor, the prior art methodology uses 1-1 replacement of the markers with the original words as removed from the original document. However, since the processing has changed the contents of the document, the context in which the removed words appear has also changed. Straight substitution of the markers with the original words can result in statements in the processed that are difficult to understand, or even makes no sense.

To overcome the limitations of the traditional approaches, the present disclosure discloses a document sanitization and enrichment technique. More particularly, implementation of the present disclosure is directed to a technique that may restrict confidential information of the organization (may be interchangeably used as enterprise) while sending the document to run on an outside model, may also be referred to as Generative AI multimodal model, to a third party. This secrecy of the confidential information can be maintained by changing the confidential information in the document with fake values/information before sending the document to the third party. The document is run on the third-party Generative AI multimodal model to generate a summary report which may be then re-enriched when received back at the user end. In other words, the fake values in the summary report may be again replaced with the confidential information to generate the relevant report which provides required information to the user. The confidential information is first replaced by fake values using an internal model, such as but not limited to Large Language Models (LLM). The large documents with the fake information then again run through external third-party Generative AI multimodal models, such as but not limited to LLM. The summary generated from the third-party Generative AI multimodal model is further enriched at the user end to fulfill the requirements of the user without any security risk regarding confidential information.

Implementation of the present disclosure is described in further detail herein with reference to foundation models. A foundation model may be described as a general-purpose generative artificial intelligence multimodal model (GAI model), such as large deep learning neural networks, that are trained using broad range of generalized, unlabeled training data and that may be capable of performing a multitude of general tasks. While implementation of the present disclosure is described in further detail herein with non-limiting reference to Large Language Models (LLMs) as an example of foundation models, it is contemplated that implementations of the present disclosure may be realized using any other appropriate foundation models. Examples of foundation models may include foundation models that generate content based on any appropriate modality (e.g., questions, answers, relationship, fake values, attributes and so on).

To improve existing tools, such as a traditional secret scrapper system, enterprises seek to leverage Generative AI multimodal model (GAI) to address drawbacks and/or limitations of the traditional secret scrapper optimization system. GAI may be described as a form of ML that includes foundation models that generate content based on training data. For example, foundation models can include LLMs, which are a form of GAI that may be used to generate text for a variety of use cases. It may be noted that GAI can be used to generate a variety of content including, but not limited to text, images, audio, and video.

According to implementations of the present disclosure, a secret control GAI model/technique may be suggested as a solution to enable the usage of an external third-party Generative AI multimodal model, for document analysis. This secret control model removes and replaces the secret/confidential information from the documents with fake information, builds a graph database of the secret information by tying different pieces of context and map different pieces of sensitive information to their context. This document may be sent to the third party Generative AI multimodal model external service to be used in analysis. Thus, sending the sanitized document should allow for most forms of analysis without compromising the confidential information. Once the results of the analysis are returned, the results may be re-enriched by replacing the fake information using the stored contextual mappings.

Further, GAI models are not specific to any domain and are only as upto date as they may be trained. Consequently, there may be a knowledge gap between GAI models and specific domains. This knowledge gap expands as data within domains changes over time (e.g., changes to data, new data) arising in a specific domain. To account for such dynamics, GAI models could be re-trained with the most-recent data. However, retraining of GAI models is time and resource intensive and is impractical to implement on a regular basis. Further, re-training does not resolve the issue of generality of GAI models (i.e., cannot be trained for a specific domain).

In view of this, implementations of the present disclosure provide a system that may include the third party having a GAI model, for example but not limited to Large Language Model (LLMs) to analyze and summarize documents from an organization. The third party LLM system is a confidential model that is trained on specific topics not accessible within the organization. Thus, to prevent data leakage to third parties, confidential information needs to be redacted from the documents before being sent externally to the third party. Use of Generative AI multimodal model on confidential documents requires an automated sanitization capability of confidential information. Such confidential information should be reinstated back in received summarized reports received from the third party Generative AI multimodal model within the organizations.

In an embodiment referring to FIG. 2, discloses an exemplary block diagram of a context sanitization and re-enrichment model 200 for context sanitization and re-enrichment of document. The model 200 may be implemented in hardware or a suitable combination of hardware and software. The system 200 receives a first document 202 as an input from a user device. The first document includes secret information (interchangeably referred to as restricted or confidential information) related to an organization and a list of questions to identify the secret information. The multiple lists of questions may be maintained such that the list of questions are context specific to a certain industrial area. The list of questions may be selected from the multiple lists based on the first document 202 received at the model 200. The first document 202 load document vectors and the list of questions to a local Generative AI multimodal model 204. The local Generative AI multimodal model 204 generates a list of answers based on the list of questions in the first document 202. The list of answers generated by the local Generative AI multimodal model 204 includes the secret information in the first document 202 that may be required to be restrained from sending it to an external Generative AI multimodal model. The secret information, may also be referred to as restricted information that may include one or more of historical or forecasted revenues, earnings or other financial results, significant new products or services or other product developments, significant new contracts or partners or the loss of a significant contract or partner, significant developments regarding Corporate's technology or business operations, cybersecurity or privacy breaches, possible mergers or acquisitions or dispositions of significant subsidiaries or assets, major new litigation or regulatory inquiries or developments in existing litigation or inquiries, significant developments in borrowings, or financings or capital investments, significant changes in financial condition or asset value or liquidity issues, changes in senior management, changes in compensation policies, changes related to Corporate's auditors, significant changes in corporate strategy, changes in accounting methods and write-offs, and stock offerings, stock splits or changes in dividend policy.

A knowledge graph may be generated based on the list of answers and relationships that may be converted to nodes and edges respectively in the knowledge graph. Thus, some of the nodes in the knowledge graph have attributes that relates to the secret information in the first document 202. The nodes having secret information may be flagged to protect restricted content that is identified based on the questions, and later replace the restricted information with fake information. For every restricted node, a new attribute may be generated thereby replacing the secret information in the flagged nodes. The new attribute may be generated by creating a range around the original restricted attribute or by picking a random number in the range of the original restricted attribute. Thus, the nodes now include the original field and the replacement field generated by the range around or using a random number in the range of the original attribute. In other words, generating fake information for a numerical value of restricted information includes to determine a range around the numerical value and select a random number within the determined range. Also, to generate fake information for a name of restricted information comprises converting the name to a fake name or a generic descriptor of the name. The local Generative AI multimodal model 204 having the flagged nodes with original and replacement fields develop the context for the replacement fields and store the same in a context database for re-enrichment at later stage. The local Generative AI multimodal model 204 identifies all the nodes with the replacement fields and create a second document 206.

In an embodiment, a Retrieval-Augmented Generation (RAG) may be used as an architectural approach to enhance the efficacy of the local Generative AI multimodal model 204. The RAG may be used to retrieve relevant information from the first document 202. Using this retrieved data as context for the local Generative AI multimodal model 204, the RAG generates a response to be used as input by the local Generative AI multimodal model 204.

The second document 206, also referred to as a sanitized document, contains fake information (fake information may interchangeably be referred to as filler) in place of restricted attributes to maintain confidentiality of the secret information. The second document 206 may then be passed to an external third-party Generative AI multimodal model, for analysis of huge amount of data and documents provided by the organization. After running the second document 206 from the external Generative AI multimodal model 208, a third document 210 may be generated as analyzed and summarized report of the second document 206 with filler values.

The third document 210 may be again turn to vectors to create a document vector. The document vector may be referred back to the knowledge graph to search all the nodes with restricted information. The third document lacks at least some of the fake information contained in the graph, such that a number of specific flagged nodes is less than the flagged nodes from the generating a graph. The flagged nodes from the generating a graph that are not part of the specific flagged nodes correspond to restricted information in the first document for which no corresponding fake information appears in the third document. The flagged nodes with the restricted information may be searched to retrieve all edges connected to the flagged nodes and a set of nodes further connected to the edges of the flagged nodes. Now, based on the relationship of the edges and the nodes connected to these edges, specific nodes may be determined in the third document which may have fake value. The specific nodes with fake values in the third document, once confirm the relations with edges and further with a node from the set of nodes, may be selected to replace the fake value with the original value. The fake values in these nodes may be replaced using the context database created at the time of replacement of the fake values in the second document. Thus, by replacing fake values with original values a fourth document 214 may be generated by re-enrichment process disclosed above. The fourth document is context based summary report or analysis report of the original document, herein referred to as the first document 202. It should be appreciated that the system 200 automates context sanitization and re-enrichment of large organizational data without sharing the confidential information of the organization with the external third party.

The use of above disclosed model 200 thus overcome limitations of traditional approaches by offering higher data privacy and security, balancing data accessibility and confidentiality, efficiently handle confidential data, enhance cyber security, and protect intellectual property as only fake values in the document are sent to the third party to run through the third-party Generative AI multimodal model instead of original document with confidential information. Further, the system disclosed in the present disclosure enables virtual assistants to overcome limitations of traditional approaches by ensuring data privacy and mitigating incorrect and/or biased information.

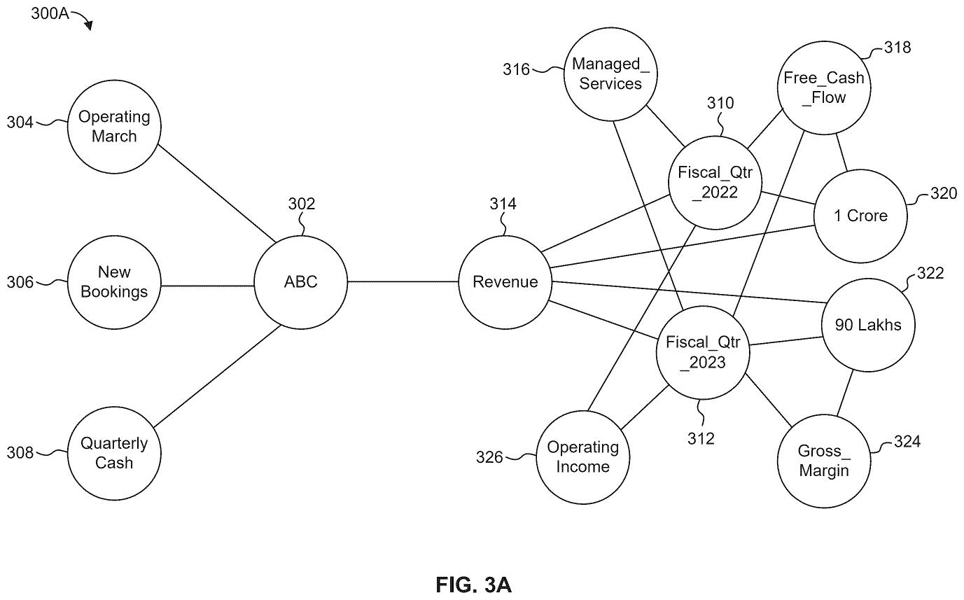

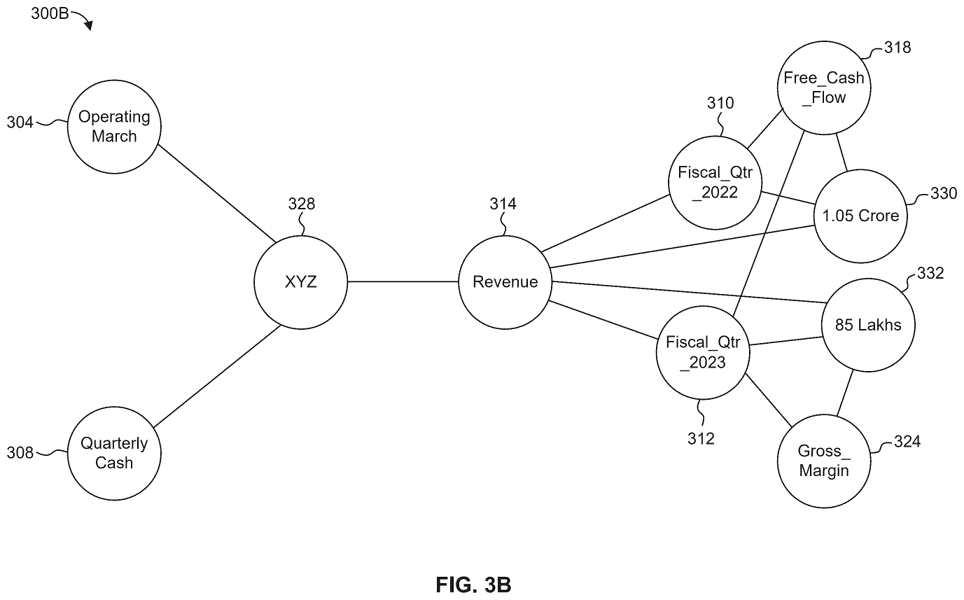

FIGS. 3A and 3B show some example representations of the knowledge graphs 300A and 300B that may be used to disclose financial data of the organization in accordance with the examples disclosed herein. FIG. 3A discloses the knowledge graph 300A having the ABC node 302 of the knowledge graphs 300A that may pertain to an entity with attributes such as operating March 304, new booking 306, quarterly cash 308 and revenue 314, etc. One of the attributes associated with the revenue 314 may include information such as values 1 crore in node 320 and 90 lakhs in node 322, which may be expressed by the organization in balance sheets of the organization. The revenue 314 further disclose other attributes as a Fiscal Qtr_2023 in node 312 and a Fiscal Qtr_2022 in node 310. The revenue 314 may have additional attributes as the Fiscal Qtr_2023 in node 312 and the Fiscal Qtr_2022 in node 310. The Fiscal Qtr_2022 310 includes attributes such as managed_services 316, Free_cash flow 318, operating income 326 and 1 crore 320. Similarly, the Fiscal Qtr_2023 312 may additionally include attributes such as operating income 326, gross_margin 324, the managed_services 316, the Free_cash flow 318 and 90 lakhs 322. The node 320 disclosing value 1 crore has a relationship with the Free_cash _flow node 318 represented by an edge between the node 320 and 328. Similarly, the node 322 disclosing value 90 lakhs has a relationship with node the Gross_Margins 324, represented by an edge between the node 322 and 324. Thus, the knowledge graph 300A discloses financial information of the organization which includes some confidential information to be protected before sending the financial data to the external Generative AI multimodal model 208. The confidential data may be flagged and replaced with fake information. For example, the confidential information is supposed to be in flagged nodes 302, 320 and 322.

FIG. 3B discloses a knowledge graph generated by replacing the original values in flagged nodes 302, 320 and 322 of FIG. 3A with fake information to rename these nodes as 328, 330 and 332 respectively. Thus, the original data in 302 regarding entity name “ABC” is replaced with “XYZ” in node 328. The values “1 crore” in node 320 is replaced with “1.05 crore” to rename as 330 and the values “90 lakhs” in node 324 is replaced with “85 lakhs” to rename it as 332. These fake values are incorporated to restrict disclosing the secret/confidential information regarding financial details of the organization to the third party having the external Generative AI multimodal model. The summary report received back from the external Generative AI multimodal model 208 may be analyzed to determine nodes with fake information by studying the edges and nodes related to the edges.

In the example disclosed in the present disclosure, the model 200 may determine that originally the node 320 having edges connected to nodes 314 and 318 has a different information as compared to the information disclosed in the knowledge graph 300A. Similarly, the model 200 may determine that originally the node 302 having edges connected to nodes 304, 306, 308 and 314 has a different information as compared to the information disclosed in the knowledge graph 300A. Furthermore, the model 200 may determine that originally the node 322 having edges connected to node 314 and 324 has a different information as compared to the information disclosed in the knowledge graph 300A. Therefore, the model 200 determines that in the document vector generated from the third document 210, the flagged nodes with fake information are nodes 328, 330 and 332 whose values may be replaced with original values referring from the context database. Also, in case of sensitive images, before sharing the sensitive images, the images may be turned into text, and embedded in the knowledge graph, sanitized, and then turned back into a “fake” image (or shared in the form of “fake text”) with the Gen AL smultimodal model.

It should be appreciated that the knowledge graphs 300A and 300B makes the context sanitization and re-enrichment model 200 more flexible that can restrict confidential information of the organization to be disclosed to the third party. By using the knowledge base of the corresponding vertical, the model 200 can be employed within the vertical without additional training. Such use without the need for training enables a more flexible context sanitization and re-enrichment of the information in the organizational documents that saves the time and efforts to gather training data and to train the context sanitization and re-enrichment model 200 for the necessary functions using the training data, thereby maintain confidentiality of the information. Thus, the present disclosure overcome the problems with traditional secret scrapper systems by summarization of the document without losing context. The traditional secret scrapper systems lose the context due to redaction of the information from the document.

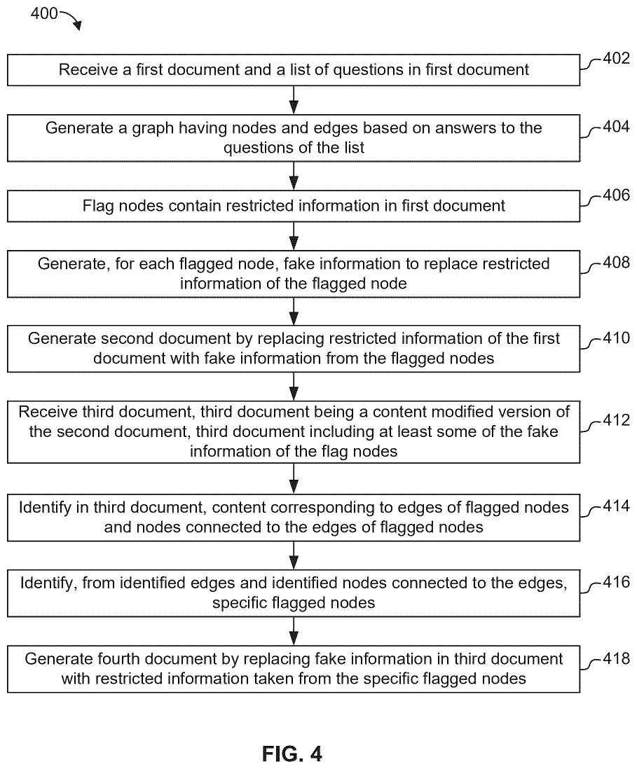

FIG. 4 illustrates a flow diagram that presents an example method for context sanitization and re-enrichment of the confidential information in the document, in accordance with present disclosure. The flow diagram 400 discloses a step 402 to receive a first document 202 from a user device, containing restricted information and a list of questions for the first document. The first document includes secret/confidential information related to an organization and a list of questions to identify the secret information. The multiple lists of questions may be maintained such that the list of questions is context specific to a certain industrial area. The list of questions may be selected from the multiple lists based on receiving the first document 202.

The method further discloses a step 404 to generate a graph based on answers to the list of questions. The first document 202 load document vectors and the list of questions to a local Generative AI multimodal model 204. The local Generative AI multimodal model 204 generates a list of answers based on the list of questions in the first document 202. The list of answers generated by the local Generative AI multimodal model 204 includes the secret information in the first document 202 that may be required to be restrained from sending it to an external Generative AI multimodal model 208. Based on the generated list of answers, a knowledge graph may be generated that disclose nodes and the relationships between the nodes, referred to as edges. Thus, some of the nodes in the knowledge graph have attributes that relates to the secret information in the first document 202. The graph includes nodes and edges in which the edges connect different nodes based on relations between the nodes. The nodes represent attributes in the first document and the edges represent relationship reflected in the first document between the attributes of the nodes.

By way of non-limiting example, if the answer to a question was “Company A is worth $100 million under John Smith's as CEO,” then one node would be “Company A”, another node would be “$100 million” with an edge relationship would be “revenue”. Other nodes would be “John Smith” and “CEO” with an edge relationship of “position.”

The method also includes a step of flagging 406 to flag the nodes that contain any restricted information within the first document. The nodes having secret information may be flagged to protect restricted content that is identified based on the questions. In the example above, “$100 million” would be considered confidential information, but “Company A” would not.

The method also discloses a step 408 to generate fake information for each of the flagged nodes to replace the restricted information of the flagged node. For every restricted node, a new attribute may be generated thereby replacing the secret information in the flagged nodes. The fake information preferably has some contextual relationship with the original content.

The method additionally includes a step 410 to generate a second document 206 by replacing the restricted information of the first document with the fake information from the flagged nodes. Generating fake information for a numerical value of restricted information includes to determine a range around the numerical value and select a random number within the determined range. Also, to generate fake information for a name of restricted information comprises converting the name to a fake name or a generic descriptor of the name. For example, if the original content is a number, then the fake content may a range around the numerical value and selecting a random number within the determined range. So, for the $100 m example above, the methodology could select a random value from within 20% of the original value. If the original content is a person's name, then a fake random name could be used. If the original content is a company name, then a fake name or a generic descriptor could be used (e.g., “Boeing” could be replaced with the fake “AMC airlines” or generic “airline manufacturer”.

The method further includes a step 412 to receive a third document 210, generated as a content modified version of the second document by passing the second document through the external Generative AI multimodal model 208. A non-limiting example of the third document would be a summary of the second document. The third document includes at least some of the fake information of the flagged nodes.

The method also includes a step 414 to identify in third document, content corresponding to edges of flagged nodes and nodes connected to the edges of flagged nodes identify content within the third document that corresponds to content of flagged nodes from the previously established graph.

A straight match of content in the third document to fake flagged nodes may yield inaccurate results. For example, suppose the third document included $80 m twice, once as a fake value that replace confidential information (“Company A made $100 m”, changed to “Company A made $80 m” as the fake) and one as an original value that was not confidential and never changed (“It's like a $8 0m party”). Correcting both instances of $80 m to $100 m would be incorrect, as it would change an original value.

The method also includes the step 416 to identify, from identified edges and identified nodes connected to the edges, specific flagged nodes the methodology searches the third document for the presence of content from flagged nodes as well as content from edges and connected nodes to the flagged nodes. This is effectively a document context check, in that the presence of the flagged node content along with the edge relationship and the connected node reflect that the fake information is appearing in the context in which the original information was found in the first document.

Thus, in the examples above, $80 m would correspond to a flagged node twice, but only one appearance would also have the connected node of “Company A” and edge relationship of “revenue”. The methodology would thus identify $80 m as a fake value for “Company A made $100 m” but ignore “It's like a $80 m party” which lacked any corresponding connected nodes or edge relationships.

The method further includes a step 418 to generate a fourth document 216 by replacing the fake information in the third document with restricted original information in the specific flagged nodes using an enrichment engine 212. The specific nodes with fake values in the third document, once confirm the relations with edges and further with a node from the set of nodes, may be selected to replace the fake value with the original value. The fake values in these nodes may be replaced using the context database created at the time of replacement of the fake values in the second document.

The above methodology provides a technical solution to technical problem of traditional methods. In the identification of confidential information for removal, the use of a list of specific questions to the document minimizes the reliance on human judgment to identify confidential content in the first document. In the document processing, the use of context specific fake information rather than redactions or symbols ensures that the document processing preserves context without revealing the confidential information to the document processor. In restoring the original information to the processed documents, the use of flagged nodes in combination with connected nodes and edge relationships uses context to differentiate between fake information and real information that appear the same in the processed document.

It should be appreciated that although implementations described herein are in connection with data secrecy and confidentiality, the model 200 may be utilized to data privacy and security, balancing data accessibility and confidentiality, efficiency handle complex data, maintain regulatory compliances, enhance overall cybersecurity, and protect intellectual property using the flow diagram 400.

In contrast to the secret scrappers available in the art, the present disclosure discloses a method that attempts to identify non structured secret information, like in a year-end fiscal report, profit and revenue figures, and store this information locally at the user end by removing it from the document to be sent to the third party. This enables the organization to continue the workflow processes by sending the document to an external Generative AI multimodal model for summarization or analysis. The summary/analysis report returned to the organization can be re-enriched with the original secret information, mitigating the breach of confidentiality risk. This disclosure provides a model to send the documents to external third parties to be processed or analyzed without sharing the contextual confidential information being handled by the external parties. Thus, mitigating the risk of leakage of the confidential information to the third party or the chance of losing the context regarding restricted information of the organization. At the same time recovering meaningful analyzed report received from the external Generative AI multimodal model enriched with restricted information thereby enhances efficacy and security due to the use of the model disclosed in the present disclosures.

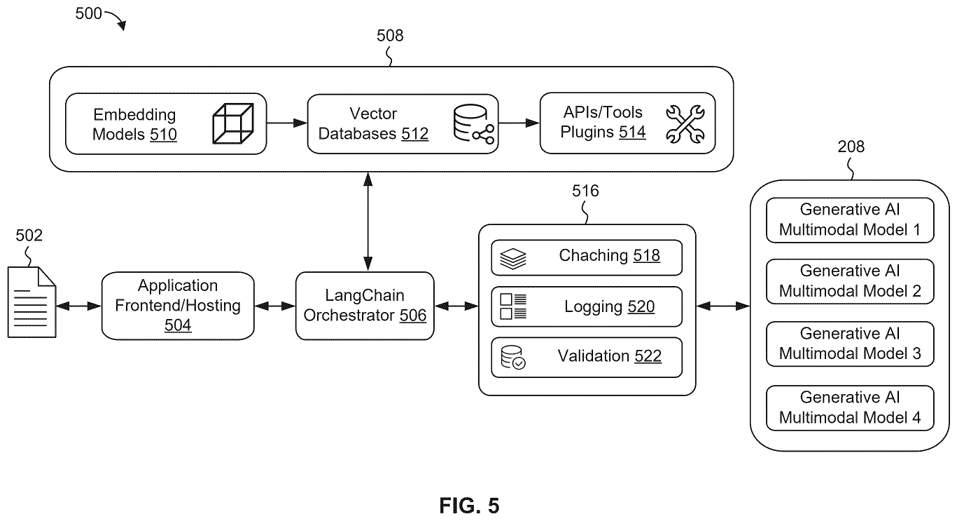

FIG. 5 illustrates a context sanitization and re-enrichment system architecture in accordance with the present disclosure. The system 500 discloses context sanitization and enrichment, by replacing the confidential information in the document with fake information (also referred to as filler values) before sending the document outside the organization to the third party external Generative AI multimodal model for analysis and summarization, and then again enriching back the received summary. The received analyzed/summarized report may be re-enriched again by replacing the fake information with the original restricted information. The system 500 discloses a first document 502 received at an application frontend/hosting 504 from a user device. The received first document 502 includes several secret/confidential information and a list of questions regarding the information in the first document. The answers to the list of questions help determining attributes of nodes and secret information to construct a knowledge graph generated at Langchain Orchestrator 506. The knowledge graph further discloses edges based on the relationship of the nodes disclosed using the list of answers. The system 500 generates a catalogue of prompts 508 while constructing the knowledge graph regarding potential secrets that may be uploaded in a vector database 512 (also referred to as context database in the present disclosure). This catalogue may be generated from an ontology of questions used to identify secrets in the document and answers to the questions regarding confidential information or may be generated by a domain expert in the field. The vector database 512 then replaces the secret/confidential information in the first document 502 to generate the second document 206 to be sent to the third party external Generative AI multimodal model. The second document sent to the external Generative AI multimodal modelmay be a sanitized document having filler information in the place of confidential information. APIs/tool plugins 514 may be stored in the vector database 512 during the process of document sanitization. The embedding models 510, the vector database 512 and the API/tools plugins 514 together may be used for prompt generation. The sanitized second document may be provided to the external Generative AI multimodal model 208 for further processing. The Generative AI multimodal model 208 further includes several Generative AI multimodal models, for example, Generative AI multimodal model1, Generative AI multimodal model 2, Generative AI multimodal model 3, LLM 4 and the different Generative AI multimodal models may be trained with different data sets to gain specific expertise to perform the required task. In the present disclosure, one of the multiple Generative AI multimodal models disclosed in the external Generative AI multimodal model 208 may be utilized to generate a summary or an analysis report to be provided back to the system 500 as the third document 210.

The received third document 210 may be re-enriched using the model 500 to reconstruct the analyzed summary report received out of the external Generative AI multimodal model 208. The external Generative AI multimodal model 208 may be located outside the premises of the user to which the sanitized documents with fake information may be sent. The external Generative AI multimodal model 208 analyzes the sanitized document and generates a summarized report for the end user. The received summary report from the external Generative AI multimodal model 208 contains fake information in specific flagged nodes. The summary report may be converted into document context vector using Generative AI multimodal model embedding vectors from embedding models 510. These vectors may be stored in the vector database 512. APIs/tool plugins 514 were initially stored in the vector database 512 during the process of document sanitization. The embedding models 510, the vector database 512 and the API/tools plugins 514 together may be used for prompt generation 508. The graph database 516 may be loaded with the secret information during caching 518, logging 520 and validation 522 processes. At LangChain Orchestrator 506, LangChain facilitates the creation of model 200 such as Generative AI multimodal model-driven applications. The LangChain orchestrates and controls the execution of chains and agents to solve specific problems by managing data flow, coordinating components, and ensuring effective responses to user interactions and changing circumstances. At 506, for each tagged secret in the graph database, a prompt is constructed with mapped secret and filler information. Thus, the local Generative AI multimodal model, may be queried using prompt to reconstruct response document with confidential information replacing filler information. This re-enriched document (fourth document 214) may be hosted at an Application Frontend/Hosting 504 to display re-enriched fourth document 214 with confidential information for the end user.

It should be appreciated that the summary document generated from the external Generative AI multimodal model may be a different document than the document from which the secrets were collected from. Because of the stored mappings of the secret information and the filler information saved in the knowledge database and mapped using the relation of nodes and edges, the summarized document even though it is completely different from the original document, the present disclosure provides technique for re-enrichment of the document by reconstructing it with the original confidential/secret value.

Once identification of secrets is possible and automatable, the disclosed model can enable many business workflows, especially regarding external document transfer thereby maintaining confidentiality.

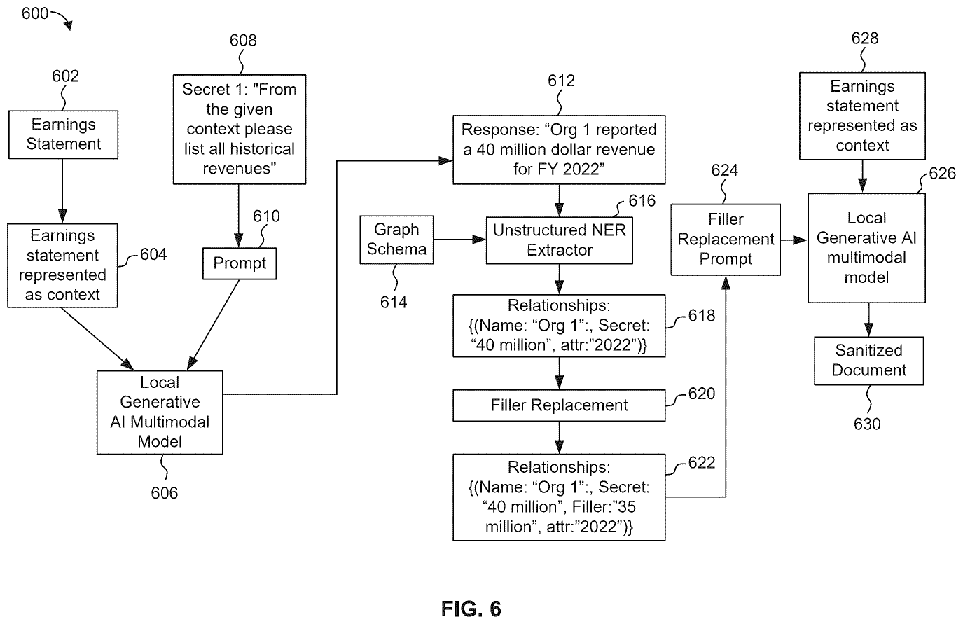

FIG. 6 illustrates an exemplary flow diagram 600 as an example model 200 to generate an automated sanitized. FIG. 6 discloses receiving an earning statement 602 from a user device containing restricted information and a list of questions for the earning statement 602. The earning statement 602 is converted into context document vector at block 604, for example an earnings statement represented as context. The context from the context document vector is stored in a document handler 606. At block 608, Secret 1:“From the given context please list all historical revenues”, discloses a list of answers to the list of questions disclosed in the earnings statement 602 to determine all the historical revenues. At block 610, a prompt is generated based on the list of answers. The inputs from blocks 604 and 610 are input to a local Generative AI multimodal model at block 606. Thus, vectors and prompts are provided as inputs to the local Generative AI multimodal model. The response generated from the local Generative AI multimodal model 606 is represented at block 612 as Response: “Org 1 reported a 40 million dollar revenue to FY 2022” which is further provided to 616 at unstructured NER Extractor. A graph schema 614 is constructed using nodes and edges developed from the earnings statement 602, is provided to an unstructured NER extractor at 616 which analyzes relationships. This unstructured NER extractor 616 provides inputs to block 618, i.e.—Relationships: {(Name: “Org 1”, Secret: “40 million”, attr: “2022”)} and further to filler replacement block 620. The secret “40 million” is thus replaced with fake value. Further, the block 624 with filler replacement prompt 624 along with earnings statement represented as context 628 are provided as inputs to local Generative AI multimodal model 626 (626 local LLM is same which is referred at block 606). The output of the local LLM 624/606 generates a sanitized document 630.

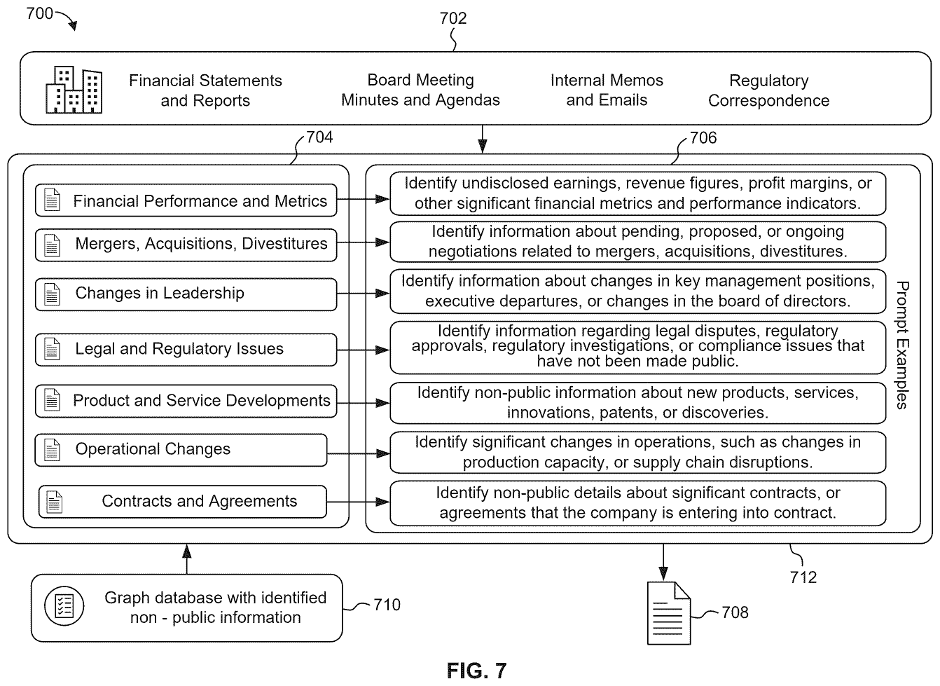

FIG. 7 illustrates some examples of the Material Non-Public Information (MNPI) related to the organization that may have an impact on various factors if made public. Examples of such material information may include (but are not limited to) facts concerning:
historical or forecasted revenues, earnings or other financial results;
significant new products or services or other product developments;
significant new contracts or partners or the loss of a significant contract or partner;
significant developments regarding Corporate's technology or business operations;
cybersecurity or privacy breaches;
possible mergers or acquisitions or dispositions of significant subsidiaries or assets;
major new litigation or regulatory inquiries or developments in existing litigation or inquiries;
significant developments in borrowings, or financings or capital investments;
significant changes in financial condition or asset value or liquidity issues;
changes in senior management;
changes in compensation policies;
changes related to Corporate's auditors;
significant changes in corporate strategy;
changes in accounting methods and write-offs; and
stock offerings, stock splits or changes in dividend policy.

FIG. 7 further illustrates the Material Non-Public Information (MNPI) 700, having source of MNPI as one or more of financial statements and reports, board meeting minutes and agenda, internal memos and emails, regulatory correspondence etc. represented as 702. The source 702 may have significant impact on the growth, business and shares of the enterprise if confidential information is disclosed in public. The block 712 represents some examples of list of questions 704 that may disclose corresponding prompt examples 706 that helps to construct prompts for ML models. A block 710 discloses graph database that may be a storage for huge amount of data and may be distributed among different databases or may be centralized locally or remotely, for example on cloud storage. 708 discloses a sanitized document generated by the ML model after removal, replacement, sanitizing, mapping of secret information with fake information to generate a final document to be send to external Generative AI multimodal model as safe document.

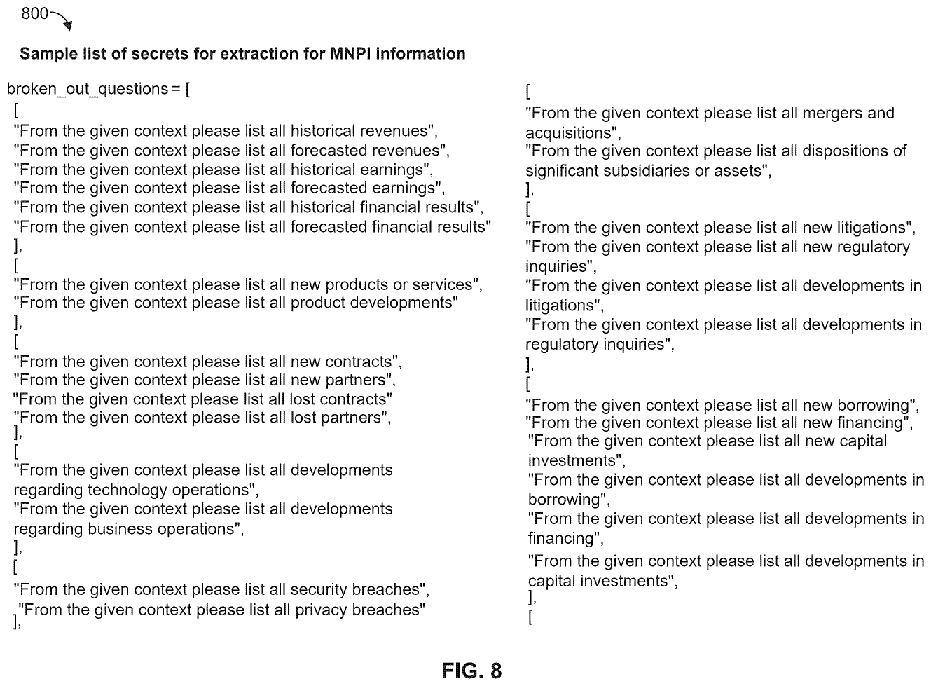

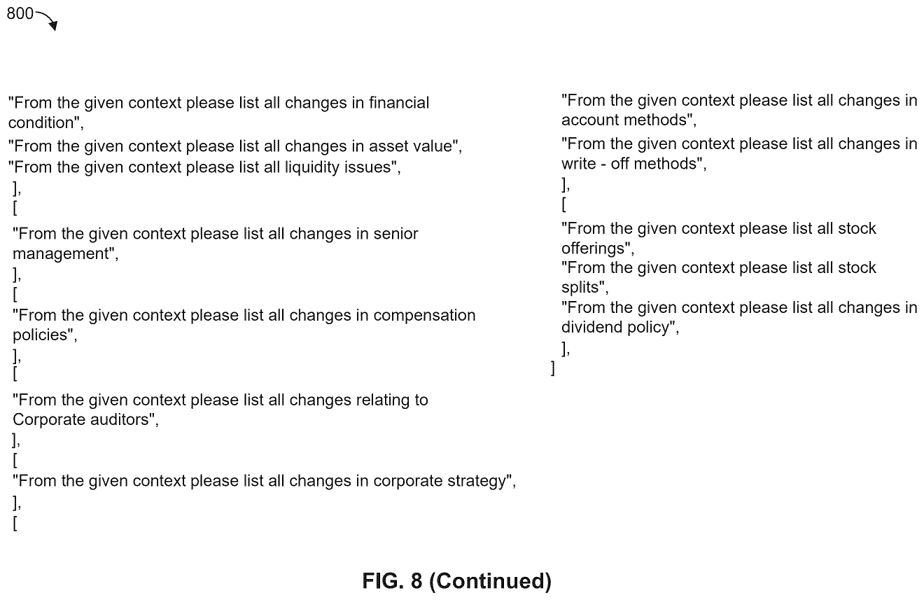

FIG. 8 illustrates examples disclosing common sample list of secrets for extraction. The information disclosed in FIG. 8 may be used to provide context regarding the list of questions sent in the first document 200/502. The answers to the list of questions exemplify the model 200 to generate nodes and edges. The context disclosed here are explained by way of non-limiting example about historical revenues, forecasted revenues, financials, contracts, partners, technology developments, business operations, security and privacy, mergers and acquisitions, audits, litigations and so on.

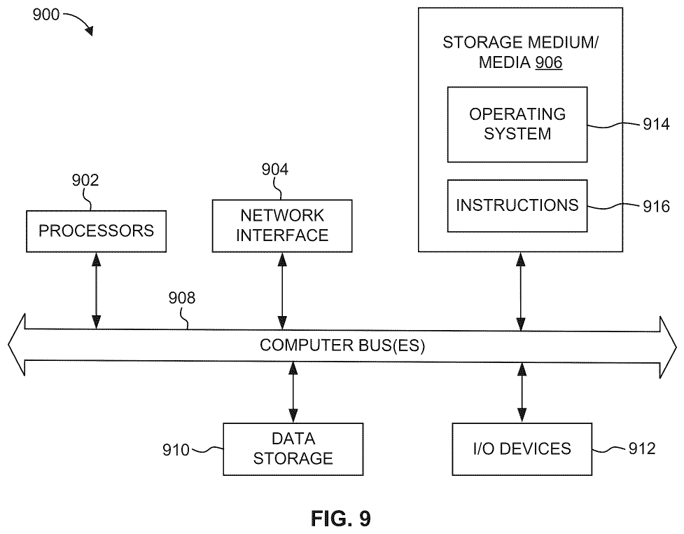

FIG. 9 illustrates a computer system 900 that may be used to implement context sanitization and re-enrichment system 500. More particularly, computing machines such as desktops, laptops, smartphones, tablets, and wearables which may be used to generate or access the data from the context sanitization and re-enrichment system 500 may have the structure of the computer system 900. The computer system 900 may include additional components not shown and that some of the process components described may be removed and/or modified. In another example, a computer system 900 can sit on external-cloud platforms such as Amazon Web Services, AZURE® cloud or internal corporate cloud computing clusters, or organizational computing resources, etc.

The computer system 900 includes processor(s) 902, such as a central processing unit, ASIC or another type of processing circuit, input/output devices 912, such as a display, mouse keyboard, etc., a network interface 904, such as a Local Area Network (LAN), a wireless 802.11x LAN, a 3G or 4G mobile WAN or a WiMax WAN, and a processor-readable medium 906. Each of these components may be operatively coupled to a bus 908. The computer-readable medium 906 may be any suitable medium that participates in providing instructions to the processor(s) 902 for execution. For example, the processor-readable medium 906 may be non-transitory or non-volatile medium, such as a magnetic disk or solid-state non-volatile memory or volatile medium such as RAM. The instructions or modules stored on the processor-readable medium 906 may include machine-readable instructions 964 executed by the processor(s) 902 that cause the processor(s) 902 to perform the methods and functions of the context sanitization and re-enrichment system 500.

The context sanitization and re-enrichment system 500 may be implemented as software stored on a non-transitory processor-readable medium and executed by the processors 802. For example, the processor-readable medium 906 may store an operating system, such as MAC OS, MS WINDOWS, UNIX, or LINUX, and code for the context sanitization and re-enrichment system 500. The operating system may be multi-user, multiprocessing, multitasking, multithreading, real-time, and the like. For example, during runtime, the operating system is running and the code for the context sanitization and re-enrichment system 500 is executed by the processor(s) 802.

The computer system 900 may include a data storage 910, which may include non-volatile data storage. The data storage 910 stores any data used by the context sanitization and re-enrichment system 500. The data storage 910 may be used to store information extracted from the user query and other data that is used by the context sanitization and re-enrichment system 500 during operation.

The network interface 904 connects the computer system 900 to internal systems for example, via a LAN. Also, the network interface 904 may connect the computer system to the Internet. For example, the computer system 900 may connect to web browsers and other external applications and systems via the network interface 904.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed in:

1. A method, comprising:
receiving a first document containing restricted information and a list of questions for the first document;
generating a graph based on answers to the questions of the list, the graph including nodes and edges connecting the nodes, the nodes representing attributes in the first document, and the edges representing relationships reflected in the document between the attributes of the nodes;
flagging those of the nodes that contain any of the restricted information within the first document;
generating, for each of the flagged nodes, fake information to replace the restricted information of the flagged node;
generating a second document by replacing the restricted information of the first document with the fake information from the flagged nodes;
receiving a third document, the third document being a content modified version of the second document, the third document including at least some of the fake information of the flagged nodes;
identifying, within the third document, content corresponding to edges of at least some of the flagged nodes and nodes connected to the edges of the at least some of the flagged nodes;
identifying, from the identified edges and the identified nodes connected to the edges, specific flagged nodes; and
generating a fourth document by replacing any of the fake information in the third document with restricted information taken from the specific flagged nodes.

2. The method of claim 1, wherein third document lacks at least some of the fake information contained in the graph, such that a number of specific flagged nodes is less than the flagged nodes from the generating a graph.

3. The method of claim 2, wherein any of the flagged nodes from the generating a graph that are not part of the specific flagged nodes correspond to restricted information in the first document for which no corresponding fake information appears in the third document.

4. The method of claim 1, wherein generating fake information for a numerical value of restricted information comprises determining a range around the numerical value and selecting a random number within the determined range.

5. The method of claim 1, wherein generating fake information for a name of restricted information comprises converting the name to a fake name or a generic descriptor of the name.

6. The method of claim 1, further comprising:
maintaining a plurality of lists of questions, each of the list of questions being context specific to a certain industrial area; and
selecting the list of questions, for the receiving a first document, from the plurality of lists of questions.

7. The method of claim 1, wherein the restricted information can be any of:
historical or forecasted revenues, earnings or other financial results;
new products or services or other product developments;
new contracts or partners or loss of a contract or partner;
developments regarding technology or business operations;
cybersecurity or privacy breaches;
potential mergers or acquisitions or dispositions of significant subsidiaries or assets;
new litigation or regulatory inquiries or developments in existing litigation or inquiries;
developments in borrowings, or financings or capital investments;
changes in financial condition or asset value or liquidity issues;
changes in senior management;
changes in compensation policies;
changes related to auditors;
changes in corporate strategy;
changes in accounting methods and write-offs; and
stock offerings, stock splits or changes in dividend policy.

8. A computer implemented non-transitory computer readable media containing instructions programmed to cause an electronic computer system to perform operations comprising:
receiving a first document containing restricted information and a list of questions for the first document;
generating a graph based on answers to the questions of the list, the graph including nodes and edges connecting the nodes, the nodes representing attributes in the first document, and the edges representing relationships reflected in the document between the attributes of the nodes;
flagging those of the nodes that contain any of the restricted information within the first document;
generating, for each of the flagged nodes, fake information to replace the restricted information of the flagged node;
generating a second document by replacing the restricted information of the first document with the fake information from the flagged nodes;
receiving a third document, the third document being a content modified version of the second document, the third document including at least some of the fake information of the flagged nodes;
identifying, within the third document, content corresponding to edges of at least some of the flagged nodes and nodes connected to the edges of the at least some of the flagged nodes;
identifying, from the identified edges and the identified nodes connected to the edges, specific flagged nodes; and
generating a fourth document by replacing any of the fake information in the third document with restricted information taken from the specific flagged nodes.

9. The computer implemented non-transitory computer readable media of claim 8, wherein third document lacks at least some of the fake information contained in the graph, such that a number of specific flagged nodes is less than the flagged nodes from the generating a graph.

10. The computer implemented non-transitory computer readable media of claim 9, wherein any of the flagged nodes from the generating a graph that are not part of the specific flagged nodes correspond to restricted information in the first document for which no corresponding fake information appears in the third document.

11. The computer implemented non-transitory computer readable media of claim 8, wherein generating fake information for a numerical value of restricted information comprises determining a range around the numerical value and selecting a random number within the determined range.

12. The computer implemented non-transitory computer readable media of claim 8, wherein generating fake information for a name of restricted information comprises converting the name to a fake name or a generic descriptor of the name.

13. The computer implemented non-transitory computer readable media of claim 8, the operations further comprising:
maintaining a plurality of lists of questions, each of the list of questions being context specific to a certain industrial area; and
selecting the list of questions, for the receiving a first document, from the plurality of lists of questions.

14. The computer implemented non-transitory computer readable media of claim 8, wherein the restricted information can be any of:
historical or forecasted revenues, earnings or other financial results;
new products or services or other product developments;
new contracts or partners or loss of a contract or partner;
developments regarding technology or business operations;
cybersecurity or privacy breaches;
potential mergers or acquisitions or dispositions of significant subsidiaries or assets;
new litigation or regulatory inquiries or developments in existing litigation or inquiries;
developments in borrowings, or financings or capital investments;
changes in financial condition or asset value or liquidity issues;
changes in senior management;
changes in compensation policies;
changes related to auditors;
changes in corporate strategy;
changes in accounting methods and write-offs; and
stock offerings, stock splits or changes in dividend policy.

15. A system, comprising:
a non-transitory computer readable memory storing instructions;
a processor programmed to cooperate with the instructions in memory to perform operations comprising:
receiving a first document containing restricted information and a list of questions for the first document;
generating a graph based on answers to the questions of the list, the graph including nodes and edges connecting the nodes, the nodes representing attributes in the first document, and the edges representing relationships reflected in the document between the attributes of the nodes;
flagging those of the nodes that contain any of the restricted information within the first document;
generating, for each of the flagged nodes, fake information to replace the restricted information of the flagged node;
generating a second document by replacing the restricted information of the first document with the fake information from the flagged nodes;
receiving a third document, the third document being a content modified version of the second document, the third document including at least some of the fake information of the flagged nodes;
identifying, within the third document, content corresponding to edges of at least some of the flagged nodes and nodes connected to the edges of the at least some of the flagged nodes;
identifying, from the identified edges and the identified nodes connected to the edges, specific flagged nodes; and
generating a fourth document by replacing any of the fake information in the third document with restricted information taken from the specific flagged nodes.

16. The system of claim 15, wherein third document lacks at least some of the fake information contained in the graph, such that a number of specific flagged nodes is less than the flagged nodes from the generating a graph.

17. The system of claim 15, wherein any of the flagged nodes from the generating a graph that are not part of the specific flagged nodes correspond to restricted information in the first document for which no corresponding fake information appears in the third document.

18. The system of claim 15, wherein generating fake information for a numerical value of restricted information comprises determining a range around the numerical value and selecting a random number within the determined range.

19. The system of claim 15, wherein generating fake information for a name of restricted information comprises converting the name to a fake name or a generic descriptor of the name.

20. The system of claim 15, the operations further comprising:
maintaining a plurality of lists of questions, each of the list of questions being context specific to a certain industrial area; and
selecting the list of questions, for receiving a first document, from the plurality of lists of questions.
